(19) United States
(12) Patent Application Publication
(10) Pub. No.: US 2014/0082069 A1
(43) Pub. Date: Mar. 20, 2014

(54) AUTOMATED COORDINATION OF RIDE SHARING BETWEEN MEMBERS OF SOCIAL GROUP

(71) Applicants: Devrim Varoglu, Santa Clara, CA (US); Swapnil R. Dave, Santa Clare, CA (US)

(72) Inventors: Devrim Varoglu, Santa Clara, CA (US); Swapnil R. Dave, Santa Clare, CA (US)

(73) Assignee: Apple Inc., Cupertino, CA (US)

(21) Appl. No.: 13/621,404

(22) Filed: Sep. 17, 2012

(51) Int. Cl. G06F 15/16

(52) U.S. Cl. 709/204

(57) ABSTRACT

Ride-sharing transportation arrangements can be electronically coordinated between members of a social group. The coordination can involve allowing members to electronically request or offer rides, gathering information pertinent to the ride share (e.g., a current or home location or a suspected destination location based on invitation response), generating proposed ride-sharing transportation routes, and sequentially presenting the proposed routes to members in order to arrive at an agreeable arrangement without unduly bothering involved members. Ride-sharing can thus be promoted due to the ease of the coordination, ride-sharers' familiarity and comfort with each other, and potentially, due to ride-sharers' overlap in destination locations.

### BACKGROUND

The present disclosure relates generally to automatically coordinating ride-sharing arrangements between members of a social group, by determining a proposed transportation route and/or driver assignment and transmitting the proposed route and/or assignment to a user device of a member of the group.

Frequently, passenger seats remain empty in vehicles being driven. In fact, often, there are no passengers in vehicles. This low vehicle utilization can increase the number of vehicles on a road, increase traffic congestion, increase societal expenditures on vehicles and gas, increase the consumption of natural resources and increase pollution.

If it were possible to increase vehicle utilization, the environment and society could thereby benefit. Unfortunately, filling the empty seats can be a difficult task. For example, initial locations, destinations locations and desired departure or arrival times can vary across people. Identifying others with similar traffic plans can itself be difficult. Further, personalities of people across potential ride-sharers could conflict to a level that a ride share between the people is undesirable.

### SUMMARY

Certain embodiments of the present invention coordinate ride-sharing arrangements between members of a social group. In some instances, members of the group are not strangers (e.g., with each member knowing each other member or with at least one member knowing each other member). The social group can include, e.g., people who have accepted an electronic invitation or people in one group member's contact list (e.g., an email or phone contact list). Thus, potential ride-sharers need not worry with respect to their safety or social comfier about being in a vehicle with strangers. Rather, due to the social-group connection, members may enjoy the opportunity to talk with fellow members during a ride.

Ride shares can be coordinated in response to detecting an event having been scheduled by the social group. An event can be scheduled by a group, e.g., via an electronic (e.g., online or app-based) invitation service (e.g., Evite or an email calendar service), via a social-networking service, or via an email chain. Members who have been invited to the event and/or who accepted the invitation can be identified. The event can be associated with a destination location, such that it can be assumed that the identified members desire to arrive at the destination location. Members' initial locations (which may be a current location or anticipated future location) can be identified, e.g., by tracking locations of members' user devices or accessing a database with the members' addresses. A proposed ride-sharing transportation route can be generated based on the initial locations and the destination location. Generation of the proposed route can involve, e.g., determining street paths, determining which member will drive, determining which members will be passengers (e.g., as all members may not be included in the ride share), and/or determining pick-up and/or departure times. The proposed route can be generated by comparing multiple potential routes and evaluating an efficiency variable (e.g., related to total driving time across the group, driving time for the driver, total miles traveled by the group, miles traveled by the driver, and/or vehicle occupancy) associated with each potential route. The proposed route can be presented to one or more members. Each member can then accept or decline the proposal, and other members can be alerted of pertinent responses.

Ride-sharing embodiments can further be extended to allow for communications between members. These communications can increase the flexibility of arrangements, by allowing members to set forth their requests, offers, and availabilities. Again, the communications can be practically made more comfortable to the members due the members' familiarity with each other. Communications can include a passenger request to pick up another passenger with regard to a scheduled route, a passenger request for a ride (that may be unassociated with an event), or a driver's offer to provide a ride (e.g., generally or a ride to a set destination).

Thus, embodiments herein can encourage reduced total vehicle usage and determine efficient ride-sharing routes, thereby reducing environmental damage, traffic and total vehicle-related costs. Further, ride sharers can remain comfortable during the share-scheduling process and during the ride due to their social-group connections

In some embodiments, a method for coordinating transportation-sharing arrangements amongst members of a social group can be provided. For each member of the social group, an initial location can be identified. An estimate can be made that the members of the social group are attempting to meet at a destination location. A processor can generate a proposed transportation route that extends from a first initial location of the initial locations to one or more second initial locations of the initial locations and terminates at the destination location. The proposed transportation route can be transmitted from the processor to a first user device associated with a first member of the social group. The first member can be associated with the first initial location. An indication that the first member accepts the proposed transportation route can be received from the first user device. Information that the first member accepted the proposed transportation route can be transmitted from the processor to a second user device associated with a second member of the social group. The second member can be associated with a second initial location of the one or more second initial locations.

In other embodiments, another method for coordinating transportation-sharing arrangements amongst members of a social group can be provided. An initial location can be identified for each member of the social group. A request for a transportation-route accommodation can be received from a first user device associated with a first member of the social group. The request can identify the social group. A proposed transportation route can be generated by a processor. The proposed transportation route can extend from a first initial location of the initial locations to one or more second initial locations of the initial locations. The proposed transportation route can accommodate the request. The proposed transportation route can be transmitted from the processor to a second user device associated with a second member of the social group. An indication that the proposed transportation route is accepted can be received from the second user device.

In still other embodiments, yet another method for coordinating transportation-sharing arrangements amongst members of a social group can be provided. At a processor, a request for a transportation-route accommodation can be received from a first user device. The request can identify a first social group, and the request can be associated with a first person. At the processor, a preliminary offer to provide a ride share can be received from a second user device. The offer can identify a second social group, and the offer can be associated with a second person. A subset of the requests can be identified by the processor, such that for each request within the subset, an associated first person is in the second social group and the second person is in an associated first social group. Information can be transmitted from the processor about the subset of the requests to the second user device.

Other embodiments are directed to systems, mobile electronic devices, and computer readable media associated with methods described herein.

These and other embodiments of the invention along with many of its advantages and features are described in more detail in conjunction with the text below and attached figures.

### BRIEF DESCRIPTION OF THE DRAWINGS

FIGS. 1A-1B illustrate an example of coordinating a ride share between social-group members attending a same event.

FIG. 2 is a flow diagram of a process for coordinating a ride share according to an embodiment of the present invention.

FIG. 3 is a flow diagram of a process for coordinating a ride share with a shared destination location according to an embodiment of the present invention.

FIG. 4 is a flow diagram of a process for responding to a route-accommodation request according to an embodiment of the present invention.

FIG. 5 is a flow diagram of a process for responding to a ride-sharing offer according to an embodiment of the present invention.

FIG. 6 is a flow diagram of a process for identifying a pertinent subset of potential ride-share participants based on analyses of social groups according to an embodiment of the present invention.

FIG. 7 is a simplified block diagram of an implementation of a device that social-group members can use to coordinate ride shares according to an embodiment of the present invention.

FIG. 8 is a simplified block diagram of an implementation of a server configured to coordinate ride shares according to an embodiment of the present invention.

### DETAILED DESCRIPTION

Certain embodiments of the present invention coordinate, through electronic and/or wireless communications, ride shares between members of a social group. The ride share can be initiated by a request for a ride, an offer to provide a ride, or an event scheduling. Members' initial locations (e.g., current locations, future locations, home locations or work locations) can be automatically detected, a destination location can be identified (e.g., based on input from a requestee passenger or potential driver or based on a scheduled event's location), and a proposed route can be automatically generated. In some instances, the proposed route includes a driver identification, a departure time, a pick-up time, and/or pick-up locations (e.g., which may be different than the initial locations). The proposed route can be presented to one or more members, and the one or more members can accept or decline the proposal.

Thus, ride shares can be easily and quickly coordinated without requiring people to repeatedly communicate about their initial locations, transportation preferences, event responses (e.g., whether they will be attending a specific event), and availabilities. Further, multiple advantages arise due to the coordination of ride shares amongst members of a social group. For example, members can feel comfortable that they will be in close quarters with someone familiar, and not a stranger, which may present fears of safety or awkwardness. As another example, members' requests and responses to proposals can include a level of informality (e.g., requesting a large route departure or requesting a pick-up of another member) that may be uncomfortable or inappropriate if the members were not acquainted.

### I. Ride-Share Coordination

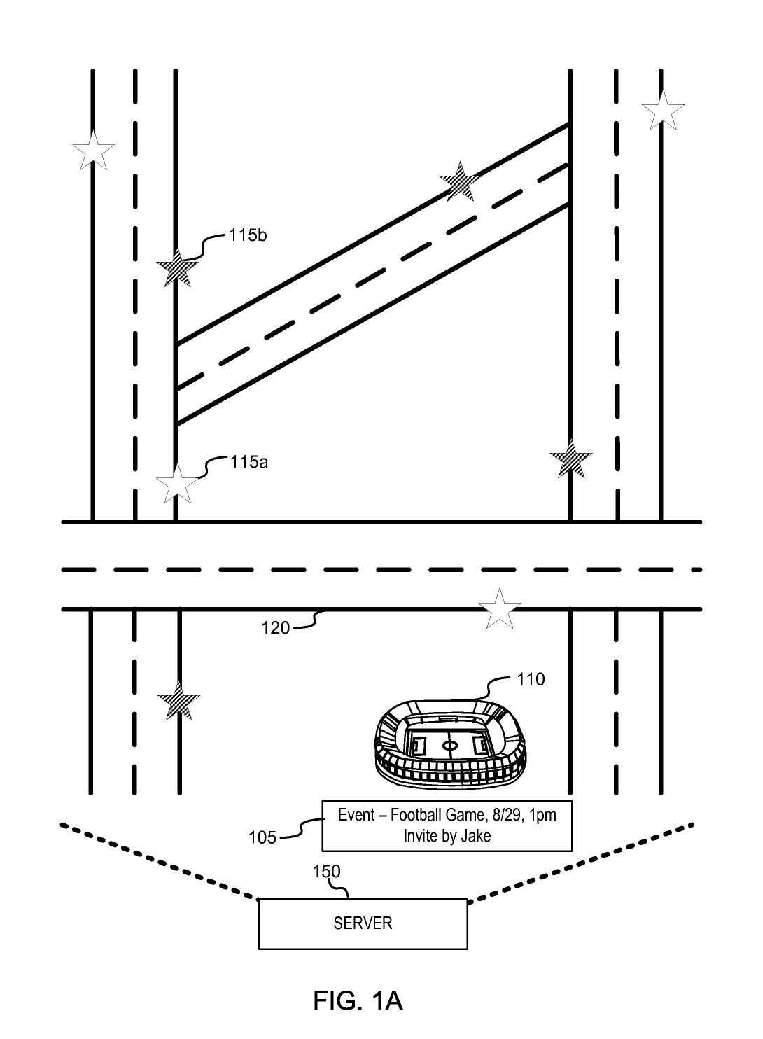

FIGS. 1A-1B illustrate an example of coordinating a ride share between social-group members attending a same event. In the example of FIG. 1A, “Jake” sent an invitation 105 to eight people to attend a football game on August 29 at 1 pm. The event is associated with an event location 110, which indicates where the event will occur. Invitation 105 was sent electronically, and invitees could electronically accept or reject the invitation. Non-responses can be assigned a default response (e.g., “Reject”). A social group can be defined as each invitee or for each invitee that accepted the invitation. In this instance, the social group is defined as each invitee that accepted the invitation as well as the invitor, Jake.

An initial location can be associated with each social-group member. The initial location can be identified based on an input from the member (e.g., a default “home” address or a location where the member anticipates being prior to departure for the event) or through automated detection of a location of a device of the member (e.g., a cell phone, smart phone, vehicle or computer). For example, the members may have a portable electronic device with a ride-share app loaded thereon. The ride-share app can utilize measurements from a location detector (e.g., cell-phone-tower transceiver or GPS receiver) to determine the device's location. In the instance of FIG. 1A, initial locations are defined as a member-provided home address which may be overridden by a member-provided pick-up location. FIG. 1 shows representations of initial locations for members of the social group 115a and representations of locations for invitees who declined the invitations 115b. Locations 115a and 115b are shown with respect to roads 120 (e.g., highways or streets).

Information about the event, the social group, and the social-group's location can be accessed by a server 150. Server 150 can include an electronic device of a member (e.g., a smartphone of a member) or a remote server.

Server 150 can generate a proposed transportation route 125, as shown in FIG. 1B. One or more efficiency variables can be considered when generating the route, such as increasing or maximizing vehicle occupancy and/or decreasing miles traveled or commute time for one or more members. In this instance, an objective is to transport as many passengers in as few vehicles as possible, and to thereafter identify the route associated with the shortest total commute time. Transportation route 125 can include a driver identification. In this instance, a member associated with initial location 115a′ is selected as a proposed driver. Thus, the route begins at location 115a′ and extends to the other initial locations 115a, terminating at the event location 110.

Proposed transportation route 125 can be presented to one or more members. For example, server 150 can transmit information about the proposed route 125 to user devices 160 associated with the members, and user devices 160 can present the information to the members. In some instances, the information is sequentially transmitted to user devices 160. In FIG. 1B, for example, the information is first transmitted to a user device 160′ of the proposed-driver member. The proposed-driver member can accept or reject the proposal. Upon acceptance, information can be transmitted to other user devices 160. The information transmitted to different devices 160 can be the same or can be different (e.g., providing the driver's device with more information or selecting only information most pertinent to a member, such as personalized pick-up and drop-off times and driver identification). Rejection of a proposal can result in an alteration of a route 125 or a generation of a new proposed route 125.

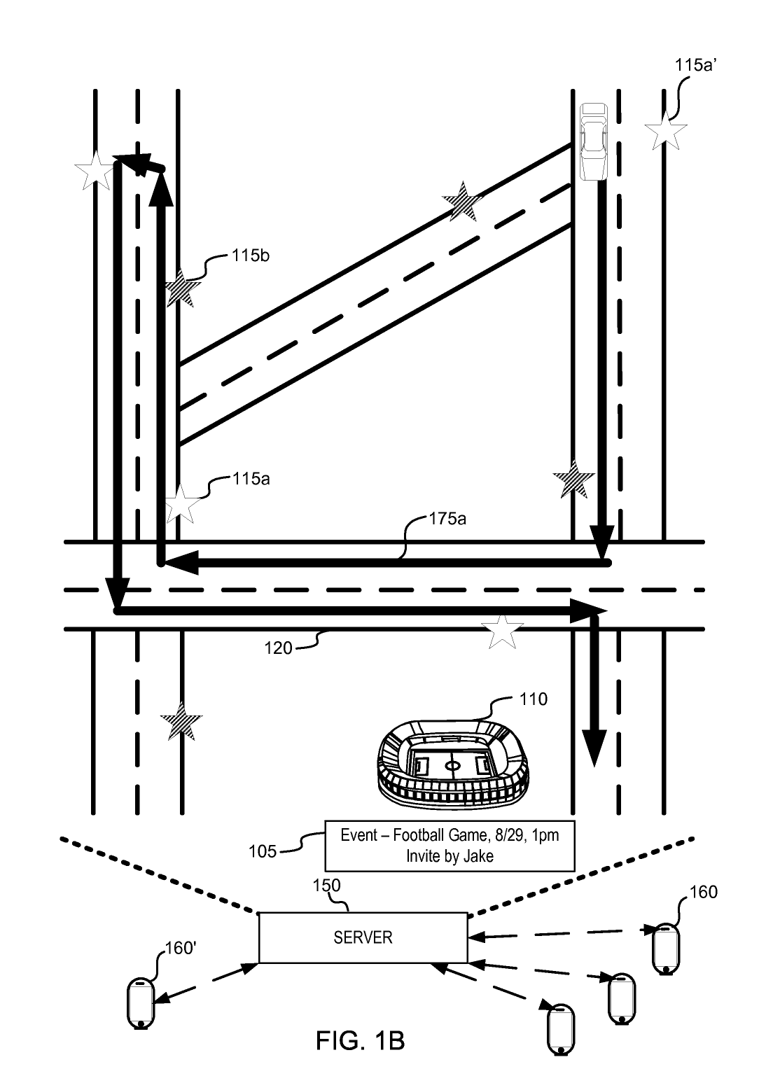

FIG. 2 is a flow diagram of a process 200 for process for coordinating a ride share according to an embodiment of the present invention. Process 200 can be implemented, e.g., in server, such as a remote server, or an electronic device.

At block 205, initial locations of social-group members can be identified. The social-group members can include people invited to an event, people who accepted an invitation to an event, people within a contact list (e.g., an email or phone contact list), or people identified as a person's “Friends”. The social group can also include a person who initiated an invitation, who manages a contact list (e.g., “John” could be included in a social group of people in John's email contact list), or who manages a friend list.

Initial locations can include locations entered by respective members. The entered locations can include categorical or default locations, such as a home address or work address, or specific locations, such as where a member anticipates being at a particular day and time or prior to a scheduled event. Initial locations can include automatically detected locations. For example, a location of a device associated with a member (e.g., a cell phone, smartphone, portable electronic device, laptop or vehicle) can be detected based on sensor measurements collected from the device (e.g., GPS signals, cell-tower signals, or Wifi access signals).

At block 210, a proposed transportation route can be generated. The route can include a set of directions from a first location, through one or more intermediate locations, ending at a final location. The final location can be, e.g., a location of an event (e.g., associated with an electronic invitation) or a destination location of a driver (e.g., as identified by the driver). The route can include, e.g., roads to be traveled, distances of travel per road, turns to make, and where to stop (e.g., to pick up other members).

Generating the proposed route can involve determining who will be a passenger for the route (e.g., who will be picked up). In some instances, it is known who will be a driver (e.g., based on a driver's offer to drive). In other instances, generating the route involves selecting a proposed driver.

Generating the proposed route can involve generating a set of potential routes, evaluating the potential routes and selecting amongst the potential routes. The potential routes can be evaluated based on one or more efficiency variables, which can relate to vehicle occupancy and/or distance traveled or commute time for one or more members. In some instances, efficiency variables are weighted. For example, a first vehicle-occupancy variable can be highly weighted and a second distance-traveled variable can be less heavily weighted. Thus, a potential route that requires a driver to circle all around a town to pick up passengers can be rejected due to the distance-traveled variable, but a potential route that requires a driver to make minor departures from his route can be selected. Examples of techniques that can be used to evaluate paths based on distance considerations are presented in S. Shekhar, J. S. Yoo, “Processing in-route nearest neighbor queries: a comparison of alternative approaches,” 2000, available at www-users.cs.umn.edu/˜jyoo/publications/gis_irnn.pdf, which is hereby incorporated by reference in its entirety for all purposes.

Generation of the route can involve considerations or constraints related to, e.g., which members have an available vehicle, sizes of available vehicles, times that members are available (e.g., which may be automatically determined by accessing members' electronic calendars or determined based on input from the members), traffic patterns, and/or driving preferences of members. Members can input data related to these considerations or constraints (e.g., available vehicles, driving preferences, or manually entered scheduling constraints) via a ride-share app or website.

In some instances, a driver is known in advance of ride-share coordination. For example, a social-group member can offer to be a driver, and generation of a proposed transportation route can thereafter assume that the member will serve as the driver. In other instances, coordination of a proposed ride share involves selecting a proposed driver from amongst members of a social group. The driver can be selected as part of the generation of the proposed transportation route (e.g., by evaluating routes with different starting points and/or evaluating different potential vehicle occupancies, such that a driver with a minivan is preferred for transport). Potential drivers can include, e.g., all group members, all group members who have indicated that they have a vehicle, or all group members who have indicated that they are willing to serve as driver.

At block 215, the proposed route can be transmitted to a first user device of a social-group member. For example, a remote server can transmit the route to user device of an established or proposed driver or to a user device of a passenger who requested to be picked up. As another example, the proposed route can be transmitted from a user device of a member requesting pick up to a user device of a proposed driver or from a user device of a member offering to provide a ride share to a user device of a proposed passenger.

The first user device can then present data pertaining to the transportation route to the member. For example, via a display, a map of the route can be presented. As other examples, a passenger list, projected commute time, and/or projected pick-up and/or arrival times can be presented.

At block 220, a response can be received. The response can accept or reject the proposed route. In some instances, the response can include a suggested adjustment to the route (e.g., elimination of one passenger generally, substitution of one passenger for another member, addition of a passenger, or change in a departure time).

If the response is an acceptance (as determined at block 225), information indicative of the acceptance can be transmitted to a second user device. The information can also include all or part of the proposed transportation route. For example, upon acceptance by a driver, the transportation route can be transmitted from a remote server to user devices of a passenger.

If the response is not an acceptance, process 200 can terminate. It will be appreciated that, in other embodiments, process 200 could instead return to block 210 and generate a new or revised proposed route. In some embodiments, such as those in which process 200 is performed by a user device of a requesting member, process 200 can present the received response in lieu of performing blocks 225 and 230.

It will be appreciated that variations of process 200 are contemplated. For example, at block 215, multiple proposed routes (e.g., which may involve a subset of evaluated potential routes and/or which may be ranked based on one or more efficiency variables) can be transmitted. At block 220, the response can include a selection of one of the routes or a rejection of all the routes. As another example, generation of the proposed route at block 210 can involve identifying one or more revised initial locations (e.g., proposing that Member X be picked up at a nearby park rather than his house). The revisions can be constrained (e.g., to limit a distance between an initial location and a revised initial location) and can be determined based on the one or more efficiency variables.

### II. Ride-Share Coordination Responsive to Event Scheduling

One opportunity to use social-group ride-sharing techniques disclosed is in response to a group attempting to meet at a single location. A ride share can thereafter be automatically scheduled or scheduled upon a scheduling request (e.g., by a member).

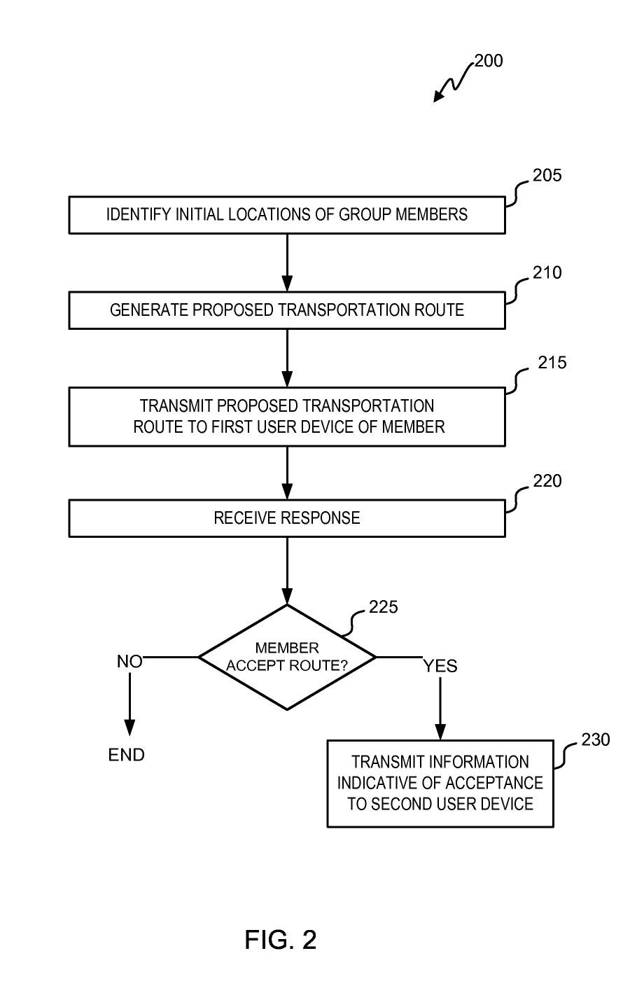

FIG. 3 is a flow diagram of a process 300 for coordinating a ride share with a shared destination location according to an embodiment of the present invention. Process 300 can be implemented, e.g., in server, such as a remote server or an electronic device. It will be appreciated that many blocks of process 300 parallel blocks of process 200.

At block 305, it can be estimated that members of a social group are attempting to meet at a destination location. In one instance, the estimate is made upon detecting that an event (occurring at the destination location) has been scheduled. The event can be associated with a social group. For example, the social group can include all people who were invited to the event, all people who indicated that they would be attending the event, all people who did not decline an invitation to the event, or all people who were invited or who accepted an invitation to the event and who are also within a same contacts or friends network (e.g., any shared network or a specific network, such as Mary's friends).

The event can be scheduled electronically. For example, a first person could send out an electronic invitation (e.g., via an app, website or calendar service) to other people. The others can electronically accept or reject the invitation, which can further be electronically tracked.

Block 310 can be implemented in a similar manner as block 205 of process 200. In some instances, members enter their initial locations when responding to an electronic invite. Block 315 can parallel block 310 of process 200. However, in this instance, it can be appropriate to assume that all group members intend to arrive at a same destination location, that being the location of the event. Blocks 320-335 can parallel blocks 215-230 of process 200.

### III. Ride-Share Coordination Responsive to an Accommodation Request

Ride shares can, in some instances, be coordinated in response to offers or requests from members. These offers or requests can be tied to an event (e.g., an event invitee offering to provide a ride) but need not be. Members' connections to each other can provide for circumstances in which requests or offers can be made with such specificity, potential inconvenience and/or conditions that could otherwise be inappropriate.

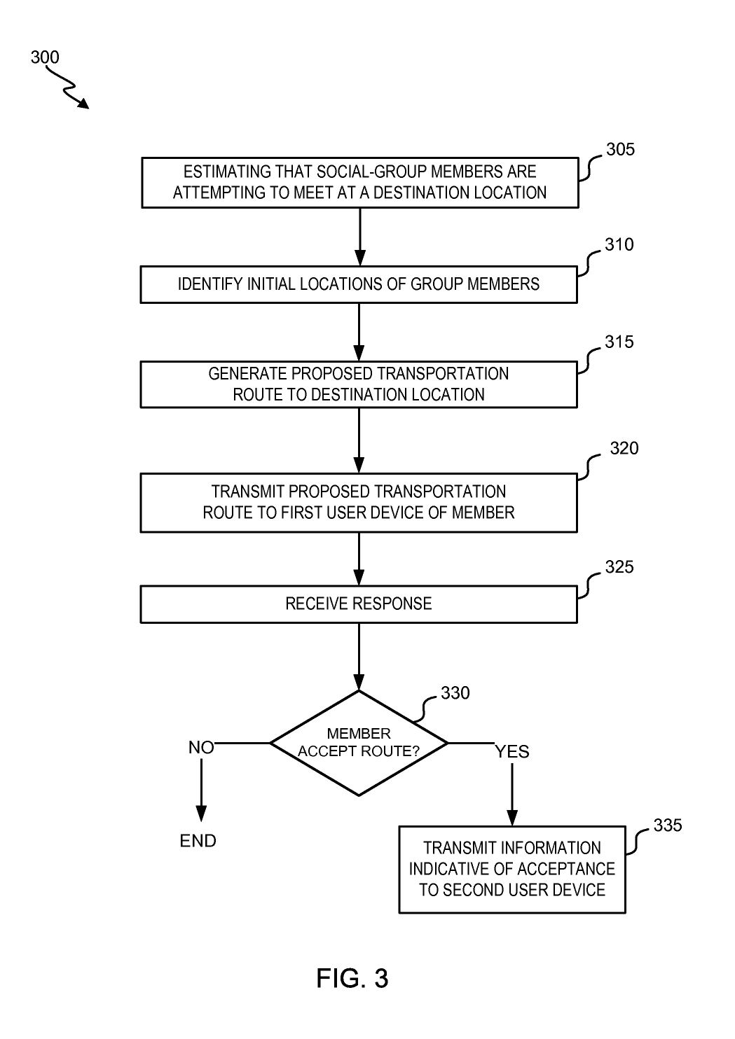

FIG. 4 is a flow diagram of a process 400 for responding to a route-accommodation request according to an embodiment of the present invention. Process 400 can be implemented, e.g., in server, such as a remote server or an electronic device. It will be appreciated that some blocks of process 400 parallel blocks of process 200.

At block 405, a transportation-route accommodation request can be received, e.g., at a server. The request can be received from a user device of a first member. The request can be associated with an initial location, which may be a current location or a location where the first member expects that he or another will be at when the accommodation would occur. The request can include, e.g., a request to pick up a first member (e.g., and bring him to a specific location), a request to pick up a third party (who may also be a social-group member), a request to make a detour in a scheduled or proposed route, a request to alter a pick-up time in a scheduled or proposed route, or a request to alter a pick-up location in a scheduled or proposed route. Thus, in some instances, the request is for an alteration of a scheduled or proposed route, which may involve the first member.

At block 410, a proposed route that accommodates the request can be generated. The proposed route can include an alteration of a previously proposed or scheduled route (e.g., an alteration determined based on an efficiency variable). In some instances, the proposed route is generated by evaluating and selecting amongst (e.g., based on an efficiency variable) a new set of potential transportation routes.

At block 415, the proposed route can be transmitted to a second device of a second member. The second member can be a driver, a third party implicated in the accommodation request, or one, some or all members (e.g., a proposed driver identified in the proposed transportation route) within a social group to which the first member belongs. For example, the accommodation request can include a request that a friend of the first member provide him a specific ride. The second member can be selected amongst a group of members identified in an electronic database as being friends with the first member. In some instances, the accommodation request and/or associated information (e.g., an identification of the first member) can be additionally or alternatively transmitted.

At block 420, a response can be received from the second user device. The response can include a rejection or acceptance of the proposed route; a rejection or acceptance of the accommodation request; suggested modifications to the request or proposed route; and/or combinations thereof. In instances in which the response includes a suggested modification of the route or request, process 400 can proceed to generate a new proposed route that accommodates the suggestion.

At block 425, information indicative of the response can be transmitted to the first user device. The information can indicate whether the first member accepted or rejected a route or accommodation request and/or can include a proposed transportation route (e.g., one accepted or rejected by the user or one generated in response to a suggestion of the second member).

It will be appreciated that variations of process 400 are contemplated. For example, if process 400 is performed on a user device of the first member, block 405 can be modified to include receiving the accommodation request from the first member, and block 425 can be modified to include presenting the information indicative of the response to the first member.

Process 400 thus illustrates how ride-sharing coordination can draw upon rather casual communications from users in order to tailor a route to members' desires. The familiarity between members of a social group can suggest that conveyance of such requests or routes based on the requests will not unduly bother receiving members. It will be appreciated that the flexible communications can stem from various parties, such as scheduled or potential passengers or scheduled or potential driver.

### IV. Ride-Share Coordination Responsive to a Driving Offer

Not only can embodiments disclosed herein respond to social-group members' ride-share requests, but coordination of ride shares can further be responsive to social-group members' offers to provide ride shares. A social group member can, e.g., offer to provide a ride and can further include constraints of the offer (e.g., identifying a social group to which the offer pertains). Ride-share requests that could be accommodated by the offer can be identified and presented to the member. A proposed transportation route associated with one or more requests can further be presented to the driver.

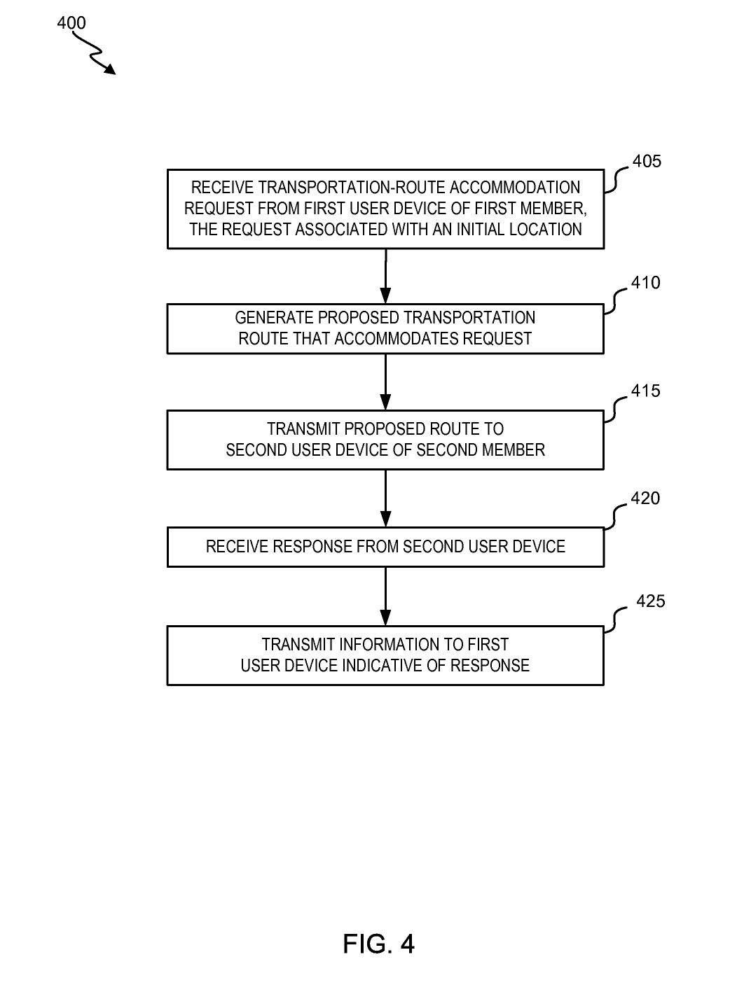

FIG. 5 is a flow diagram of a process 500 for responding to a ride-sharing offer (e.g., received from a scheduled or potential driver) according to an embodiment of the present invention. Process 500 can be implemented, e.g., in server, such as a remote server or an electronic device. It will be appreciated that some blocks of process 500 parallel blocks of process 400.

Block 505 can be implemented in a similar manner as block 405 of process 400. However, requests can be received from multiple first members. The first members can be members of a social group that a second member also belongs to.

At block 510, an offer to ride share can be received from a second user device associated with the second member. The offer can include a general offer to ride share, e.g., with a specific group or sub-group of members that are explicitly or implicitly identified. In some instances, the offer is implicitly made by the second member (e.g., by opening an app or selecting a feature when the device is traveling at an above-threshold velocity). The offer can include constraints, such as a number of pick-ups that the second member is willing to make, a maximum time or distance departure that the second member is willing to make from a planned or current route, or whether the members must be traveling to a same destination as in a planned or current route.

At block 515, a notification of one or more transportation-route accommodation requests received at block 505 are transmitted to the second user device. For example, the notification can identify those requests meeting constraints specified in the offer. The notification can include, e.g., an identification of the requesting first members, an identification of potential pick-up points and/or times, and/or an identification of potential departure points and/or times. The notification can be textually or graphically presented to the second member via the second user device (e.g., by identifying potential pick-up points with member-identifying icons on a map). In some instances, the requests are prioritized (e.g., based on an efficiency variable or past responses received from the second user device).

At block 520, a response can be received from the second user device. The response can include a confirmation that the second member is tentatively willing to accommodate an accommodation request, an identification of one or more specific requests or types of requests that the second member is tentatively willing to accommodate, or an identification of one or more specific requests or types of requests that the second member is not willing to accommodate. For example, in one instance, the second member can select (e.g., by touching) a representation of a request indicating an offer to accommodate that the specific request.

At block 525, a proposed transportation route can be generated. The proposed transportation route can accommodate one, some or all accommodation requests identified for tentative accommodation in the request received at block 520. The proposed transportation route can be selected from amongst a set of potential transportation routes based on an efficiency variable. Constraints set forth in the offer of block 510 or response 20 can be enforced when generating the proposed route.

Blocks 530-540 of process 500 can be implemented in a similar manner as blocks 415-425 of process 400. In some instances, at block 530, the proposed route is transmitted to the user device of one or more second members whose requests are accommodated via the proposed route.

It will be appreciated that variations of process 500 are contemplated. For example, block 510 can be performed prior to block 505. The offer received at block 510 can then include a general offer to ride share (e.g., such that a proposals about which accommodation requests will be accommodated is automatically determined at block 525) or a specific offer (e.g. identifying one or more requests that the second member is willing to accommodate). Block 520 can be eliminated from the process. As another example, blocks 515-520 can be eliminated from process 500. As yet another example, blocks 525-530 can be eliminated from process 500.

### V. Identifying Pertinent Ride-Share Communications

In a simple scenario, a single social group is attending an event, or members of a single social group are requesting and offering rides. However, in some embodiments, different social groups can be associated with (e.g., by having been identified by) different potential ride-share participants.

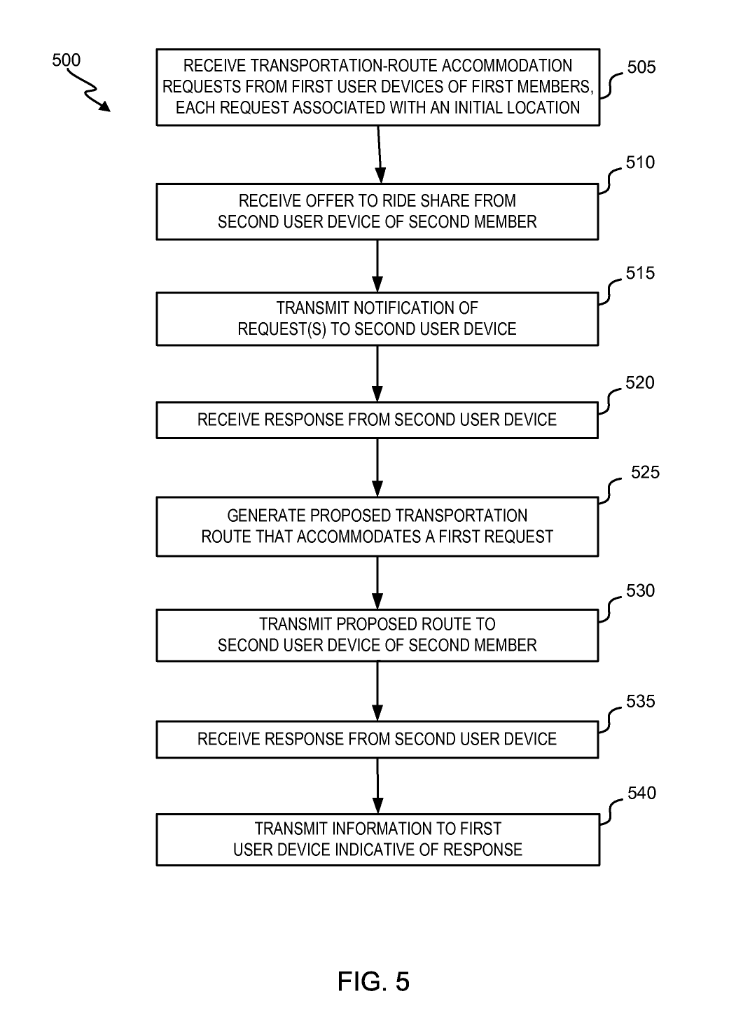

FIG. 6 is a flow diagram of a process 600 for identifying a pertinent subset of potential ride-share participants based on analyses of social groups according to an embodiment of the present invention. Process 600 can be implemented, e.g., in server, such as a remote server or an electronic device. It will be appreciated that some blocks of process 600 parallel blocks of process 500.

Block 605 can be can be implemented in a similar manner as block 505 of process 500. However, each request can be associated with a first social group. The first social groups can be groups as defined by respective members and can vary across requests. In some instances, the groups are automatically defined, e.g., based on a stored contact list or social group. For example, the first social group can be defined as a “friends” contact list stored on a first user device or associated with an online account of the first member. Because the contact list can vary across members, so also can the first social groups. In some instances, each first member can identify user names, email addresses or phone numbers of people to include in the first social group. The identification can be specific to the request or applicable to a group of requests or all requests.

Block 610 can be implemented in a similar manner as block 510 of process 500. However, the offer can be associated with a second social group. The second social group can be defined in a manner similar to a manner that a first social group is defined.

At block 615, a subset if requests is identified by analyzing the first and second social groups. Specifically, the social groups can be analyzed to identify, for each first request, whether the second member is a member of the associated first social group and whether the associated first member is a member of the second social group. To simply illustrate, if a request from Bob identifies a social group of Mary, Bill and Ann; a request from Tom identifies a social group of Mary and Mike; a request from Jill identifies a social group of Mike and Ann; and an offer from Mary identifies a social group of Jill and Bob, the subset of requests would only include the request from Bob (as Tom is not within Mary's group and Mary is not in Jill's group).

At block 620, a notification of one or more of the subset of transportation-route accommodation requests identified at block 615 are transmitted to the second user device. The notification can include, e.g., an identification of the requesting first members, an identification of potential pick-up points and/or times, and/or an identification of potential departure points and/or times. The notification can be textually or graphically presented to the second member via the second user device (e.g., by identifying potential pick-up points with member-identifying icons on a map). The requests can be prioritized or the subset of requests can be further pruned, e.g., based on an efficiency variable or past responses received from the second user device. For example, even if block 615 identifies a subset of 60 requests, a further subset of 25 of the 60 requests can be selected based on an efficiency variable and transmitted to the second user device.

It will be appreciated that process 600 can be extended to include one or more parts of process 500. For example, process 600 can continue with blocks implemented in a similar manner as blocks 520-540 or blocks 525-540 of process 500. It will further be appreciated that other variations are contemplated. For example, the offer need not be associated with a social group and the subset identified at block 615 can include requests that identify the second member in a respective first social group. As another example, one, some or all requests need not be associated with a social group and the subset identified at block 615 can include requests associated with first members in the second social group.

### VI. Device or Server

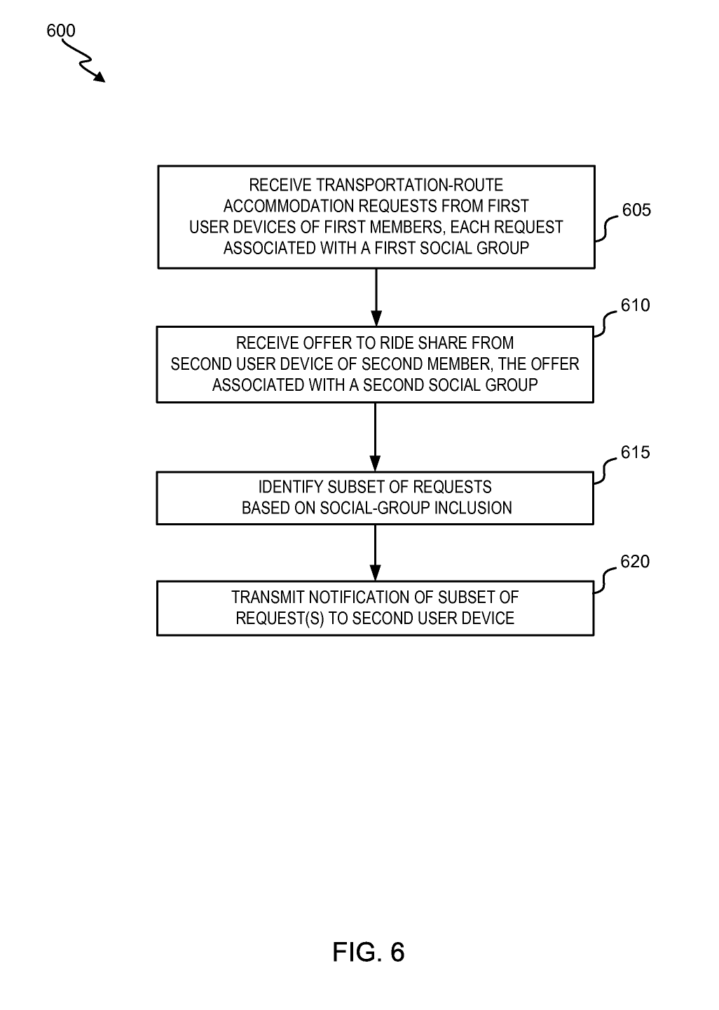

FIG. 7 is a simplified block diagram of an implementation of a device 700 that social-group members can use to coordinate ride shares according to an embodiment of the present invention. Device 700 includes a processing subsystem 702, a storage subsystem 704, a user input device 706, a user output device 708, a network interface 710, and a location detector 712.

Processing subsystem 702, which can be implemented as one or more integrated circuits (e.g., e.g., one or more single-core or multi-core microprocessors or microcontrollers), can control the operation of device 700. In various embodiments, processing subsystem 702 can execute a variety of programs in response to program code and can maintain multiple concurrently executing programs or processes. At any given time, some or all of the program code to be executed can be resident in processing subsystem 702 and/or in storage subsystem 704.

Through suitable programming, processing subsystem 702 can provide various functionality for device 700. For example, processing subsystem 702 can execute a ride-share app 714. Ride-share app 714 can provide various functionality, such as one or more parts of a process described herein and/or allowing a user to input ride-share requests, allow a user to input offers to drive in a ride share, determining a proposed transportation route, transmitting a proposed transportation route to another device of to a central server, allowing a user to view proposed transportation routes, allowing a user to input responses to proposed transportation routes and/or allowing a user to view information indicative of proposed route responses.

Storage subsystem 704 can be implemented, e.g., using disk, flash memory, or any other storage media in any combination, and can include volatile and/or non-volatile storage as desired. In some embodiments, storage subsystem 704 can store one or more application programs to be executed by processing subsystem 702 (e.g., ride-share app 716). In some embodiments, storage subsystem 204 can store other data (e.g., used by and/or defined by map app 216), such as a social-groups database 718, which can monitor a social group associated with a user of device 700. For example, social-groups database 718 can include an email contact list, a phone contact list, a defined (e.g., email) group, or a friends network. Programs and/or data can be stored in non-volatile storage and copied in whole or in part to volatile working memory during program execution.

A user interface can be provided by one or more user input devices 706 and one or more user output devices 708. User input devices 706 can include a touch pad, touch screen, scroll wheel, click wheel, dial, button, switch, keypad, microphone, or the like. User output devices 708 can include a video screen, indicator lights, speakers, headphone jacks, or the like, together with supporting electronics (e.g., digital-to-analog or analog-to-digital converters, signal processors, or the like). A user can operate input devices 706 to invoke the functionality of device 700 and can view and/or hear output from device 700 via output devices 708.

Network interface 710 can provide voice and/or data communication capability for device 700. For example, network interface 710 can provide device 700 with the capability of communicating with remote server or another device. In some embodiments network interface 710 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), and/or other components. In some embodiments network interface 710 can provide wired network connectivity (e.g., Ethernet) in addition to or instead of a wireless interface. Network interface 710 can be implemented using a combination of hardware (e.g., antennas, modulators/demodulators, encoders/decoders, and other analog and/or digital signal processing circuits) and software components.

Location detector 712 can detect a past or current location of device 700. For example, location detector 712 can include a Global Positioning Satellite (GPS) receiver that receives GPS signals identifying GPS satellites, a cell-tower detector that detects which cell tower or cell towers are carrying cellular communications associated with device 700, and/or a WiFi detector that detects WiFi access points. Location detector 712 can estimate a distance between device 700 and GPS satellites, cell towers and/or WIFi access points. Using the estimated distances and locations of the GPS satellites, cell towers and/or WiFi access points, location detector 712 can then estimate a position of device 700. The estimated location can include, e.g., geographic coordinates or an address (e.g., a street number, street name, city and/or state).

It will be appreciated that device 700 described herein is illustrative and that variations and modifications are possible. For example, device 700 can have other capabilities not specifically described herein (e.g., telephonic capabilities, power management, accessory connectivity, etc.). In a system with multiple devices 700, different devices 700 can have different sets of capabilities; the various devices 700 can be but need not be similar or identical to each other.

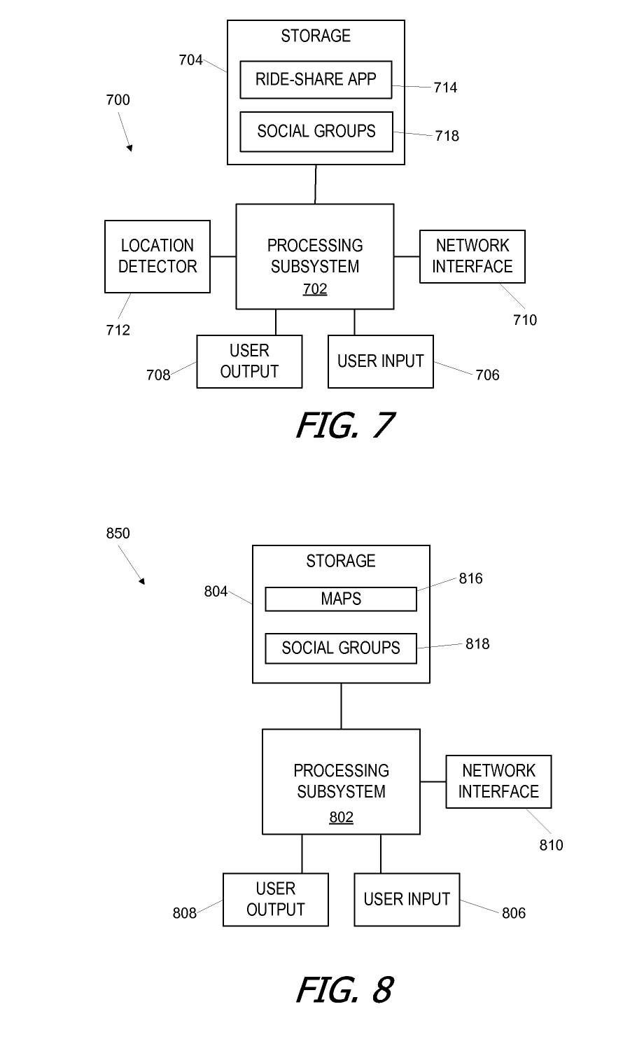

FIG. 8 is a simplified block diagram of an implementation of a server 850 configured to coordinate ride shares according to an embodiment of the present invention. Server 850 can be remote from a set of devices 700, can generate proposed ride shares, and can facilitate communications between the devices. Server 850 can include a processing subsystem 802, storage subsystem 804, a user input device 806, a user output device 808, and a network interface 810. Storage subsystem 804, user input device 806, user output device 808 and network interface 810 can have similar or identical features as storage subsystem 704, user input device 706, user output device 708 and network interface 710 of device 700 described above.

Processing subsystem 802, which can be implemented as one or more integrated circuits (e.g., a conventional microprocessor or microcontroller), can control the operation of server 850. In various embodiments, processing subsystem 802 can execute a variety of programs in response to program code and can maintain multiple concurrently executing programs or processes. At any given time, some or all of the program code to be executed can be resident in processing subsystem 802 and/or in storage subsystem 804.

Through suitable programming, processing subsystem 802 can provide various functionality for server 850. Thus, server 850 can, e.g., analyze communications between social-group members to determine whether a ride share should be proposed (e.g., based on whether an event is scheduled, whether a ride-share accommodation has been requested and/or whether a ride-share accommodating offer has been made), can generate a proposed transportation route for the ride share (e.g., which can include identifying one or more proposed passengers and a driver and pick-up and/or drop-off times), and can transmit the proposed route to one or more devices 700.

Processing subsystem 802 can generate of update one or more social groups stored in a social-group database 818, stored in storage subsystem 804. In some instances, a device 700 defines a social group and transmits it to server 850. Server 850 can then store the group as received. In some instances, server 850 generates the social group based on, e.g., users participating in an email chain, users responding to an electronic invite, or users defining friendships or connections with each other via a website.

Processing subsystem 802 can access a maps database 816 stored in storage subsystem 804 when generating a proposed transportation route. The maps database 816 can identify paths of roads (e.g., streets and highways), intersections, and/or locations (e.g., of venues, attractions, etc.). Thus, processing subsystem 802 can use the maps to determine efficient routes extending between two or more locations (e.g., social-group members' initial locations and a destination location). Further, processing subsystem 802 can use the maps to determine proposed revisions to members' initial locations.

User devices, such as user device 700, and server 850 can thus operate in a variety of ways to coordinate ride shares between social-group members. As a first illustration, a first user can use user input 706 of a first user device or a website to electronically invite a set of second users to an event. In some instances, creation and transmission of the invite is a part of ride-share app 714. A subset of the second users can each use user input 706 of a second user device or website to electronically accept the invitation Each of the subset of second user devices can further transmit an initial location, e.g., estimated based on a most common location detected by location detector 712 or based on user input. A social group can be defined as the first user and the subset of second user on the first user device (and stored in a social-group database 718) and transmitted to server 850 (via network interfaces 710 and 810), or server 850 can define the group itself (based on management of the electronic invitation or analysis of electronic communications). Server 850 can, automatically or in response to a user request made via ride-share app 714, access its maps database 815 and generate one or more proposed ride-share transportation routes. The proposed route(s) can be transmitted (via network interfaces 710 and 810) to the first user device and/or one or more of the subset of second user devices, which can present the proposal (via user output 708) to respective users. Users can accept or reject the proposal (or propose suggested revisions) using user input 706. The responses can be transmitted to server 850, which can relay the responses to other user devices or alter the proposed route(s).

As a second illustration, a first user can operate ride-share app 714 and use user input 706 of a first user device to request a ride in the near-term. The first user can further select or define a social group (e.g., which is or can be stored in social-group database 718) to which the user would like to address the request. The first user device can transmit the request to server 850 (using network interfaces 710 and 810). Server 850 can pull current locations from each of a set of second user devices, each second user device being associated with a member of the identified social group. Specifically, server 850 can send a request for the second user devices' locations, location detectors 712 can detect the locations, and the second user devices can respond to server 850. Server 850 can then access its maps database 815 and generate one or more proposed ride-share transportation routes. The proposed route(s) can be transmitted (via network interfaces 710 and 810) to the first user device or a second user device associated with the proposed route, which can present the proposal (via user output 708) to a respective user. The respective user can accept or reject the proposal (or propose suggested revisions) using user input 706. The responses can be transmitted to server 850, which can, upon acceptance, transmit (via network interfaces 710 and 810) to the other of the first user device or a second user device associated with the proposed route, which can present the proposal (via user output 708). The proposed route can then again be accepted or rejected (by the other member) using user input 706.

As a third illustration, a set of first users can operate ride-share apps 714 and use user inputs 706 of first user devices to request a ride in the near-term. Each request can be associated with a pick-up and drop-off location (e.g., as entered by the user). The first users can further select or define a social group (e.g., which is or can be stored in social-group database 718) to which the respective user would like to address the request. The first user devices can transmit the request to server 850 (using network interfaces 710 and 810). A second user can operate ride-share app 714 and use user-input 706 of a second user device to offer to provide a ride. The second user can further identify who the offer pertains to by selecting or defining a social group (e.g., which is or can be stored in social-group database 718). The second user device can automatically detect its current location via location detector 712 and transmit the offer, social group and location to server 850. Server 850 can identify ride requests that can be fulfilled by the second user (via request and/or offer constraints, such as social-group constraints) and transmit information about the identified request to the second user device. Map app 714 can then present, via user output 708, a map depicting the location of the second user and potential pick-up locations of a subset of the first users. The second user can select a request that the second user is willing to accommodate using user input 706. The selection can be transmitted to server 850, which can access its maps database 815 and generate one or more proposed ride-share transportation routes. The proposed route(s) can be transmitted (via network interfaces 710 and 810) to the second user device and/or a first user device associated with a request accommodated in the proposed route, which can present the proposal (via user output 708) to respective users. Users can accept or reject the proposal (or propose suggested revisions) using user input 706. The responses can be transmitted to server 850, which can relay the responses to other user devices or alter the proposed route(s).

It will be appreciated that user device 700 and sever 850 described herein are illustrative and that variations and modifications are possible. A user device 700 can be implemented as a mobile electronic device and can have other capabilities not specifically described herein (e.g., telephonic capabilities, power management, accessory connectivity, etc.). In a system with multiple user devices 700 and/or multiple servers 850, different user devices 700 and/or servers 850 can have different sets of capabilities; the various user devices 700 and/or servers 850 can be but need not be similar or identical to each other.

Further, while user device 700 and server 850 are described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Additionally, while user device 700 and server 850 are described as singular entities, it is to be understood that each can include multiple coupled entities. For example, server 850 can include, a server, a set of coupled servers, a computer and/or a set of coupled computers.

Still further, embodiments need not necessarily include user device 700 and server 850: that is, one or both can be omitted in some embodiments. For example, user devices 700 can provide some or all processing and/or can include some or all components disclosed with respect to server 850. To illustrate, a user device requesting a route accommodation can transmit the request to other user devices associated with a social group. A user device of a driver (e.g., storing or otherwise having access to a maps database) willing to accommodate the request can then generate a proposed route, present the route to the driver, receive a response from the driver, and then transmit information indicative of the response to a user device of an appropriate requestee. As another example, rather than relying on direct or indirect communications between user devices 700 (e.g., storing a ride-share app 712), communications can be exchanged between social-group members via a web interface (e.g., such that members log into the site to view and provide information). The web interface can be coupled to or the same as a web interface that supports the management of social groups (e.g., a social-networking site) or that provides and/or manages electronic invitations.

Embodiments described herein can electronically coordinate ride-sharing transportation arrangements between members of a social group. The coordination can involve allowing members to electronically communicate about express transportation desires (e.g., requested rides or ride-offering constraints), automatically gathering information pertinent to the ride share (e.g., a current or home location or a suspected destination location based on invitation response), generating proposed ride-sharing transportation routes, and sequentially presenting the proposed routes to members in order to arrive at an agreeable arrangement without unduly bothering involved members. Due to social-group members' familiarities with each other, ride sharing can be promoted. For example, whereas members may be unwilling to engage in ride-sharing efforts with strangers for semi-insubstantial trips, they may feel more comfortable (and potentially eager) to ride share with their friends or acquaintances.

Portions of the description can refer to particular user interfaces, such as touchscreen displays. Other embodiments can use different interfaces. For example, a user interface can be voice-based, with the user speaking instructions into a microphone or other audio input device and the device providing an audible response (e.g., using synthesized speech or pre-recorded audio clips). A combination of voice-based and visual interface elements can be used, and in some embodiments, multiple different types of interfaces can be supported, with the user having the option to select a desired interface, to use multiple interfaces in combination (e.g., reading information from the screen and speaking instructions) and/or to switch between different interfaces. Any desired form of user interaction with a device can be supported.

Embodiments of the present invention can be realized using any combination of dedicated components and/or programmable processors and/or other programmable devices. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes can use different techniques, or the same pair of processes can use different techniques at different times. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method for coordinating transportation-sharing arrangements amongst members of a social group, the method comprising:
identifying, for each member of the social group, an initial location;
estimating that the members of the social group are attempting to meet at a destination location;
generating, by a processor, a proposed transportation route that extends from a first initial location of the initial locations to one or more second initial locations of the initial locations and terminates at the destination location;
transmitting, from the processor, the proposed transportation route to a first user device associated with a first member of the social group, the first member being associated with the first initial location;
receiving, from the first user device, an indication that the first member accepts the proposed transportation route; and
transmitting, from the processor, information that the first member accepted the proposed transportation route to a second user device associated with a second member of the social group, the second member being associated with a second initial location of the one or more second initial locations.

2. The method of claim 1 further comprising determining, for at least one member of the social group, the initial location, the determination being based on preliminary initial location identified by the respective member.

3. The method of claim 1 wherein estimating that the members of the social group are attempting to meet at the destination location comprises:
accessing data pertaining to an electronic invitation to an event at the destination location; and
determining that the members of the social group accepted the invitation.

4. The method of claim 1 wherein generating the proposed transportation route comprises:
generating a plurality of potential transportation routes;
defining an efficiency variable for each of the potential transportation routes; and
selecting the proposed transportation route from amongst the plurality of transportation routes based on the efficiency variables.

5. The method of claim 1 wherein generating the proposed transportation route comprises selecting a member if the social group to be a proposed driver, wherein the first member is the proposed driver.

6. The method of claim 1 further comprising, prior to generating the proposed transportation route:
generating, by the processor, an initial proposed transportation route that extends from the first initial location of the initial locations to at least one second initial location of the initial locations and terminates at the destination location;
transmitting, from the processor, the initial proposed transportation route to the first user device; and
receiving, from the first user device, an indication that the first member rejects the proposed transportation route,
wherein the proposed transportation route and the initial proposed transportation route are different.

7. A method for coordinating transportation-sharing arrangements amongst members of a social group, the method comprising:
identifying, for each member of the social group, an initial location;
receiving, from a first user device associated with a first member of the social group, a request for a transportation-route accommodation, the request identifying the social group;
generating, by a processor, a proposed transportation route that extends from a first initial location of the initial locations to one or more second initial locations of the initial locations and that accommodates the request;
transmitting, from the processor, the proposed transportation route to a second user device associated with a second member of the social group; and
receiving, from the second user device, an indication that the proposed transportation route is accepted.

8. The method of claim 7 wherein the social group is defined based on a contact list.

9. The method of claim 7 wherein the first user device comprises the processor.

10. The method of claim 7 wherein, for at least one member of the social group, the initial location is identified by requesting a current location of an associated user device fro, the associated user device.

11. The method of claim 7 wherein the first initial location is a current location of the second user device and the second initial location is a pick-up location associated with the request.

12. The method of claim 7 wherein generating the proposed transportation route comprises:
generating a plurality of potential transportation routes;
defining an efficiency variable for each of the potential transportation routes; and
selecting the proposed transportation route from amongst the plurality of transportation routes based on the efficiency variables.

13. A method for coordinating transportation-sharing arrangements amongst members of a social group, the method comprising:
receiving, at a processor, a request from a first user device for a transportation-route accommodation, the request identifying a first social group, and the request being associated with a first person;
receiving, at the processor, a preliminary offer from a second user device to provide a ride share, the offer identifying a second social group, and the offer being associated with a second person;
identifying, by the processor, a subset of the requests, such that for each request within the subset, an associated first person is in the second social group and the second person is in an associated first social group; and
transmitting, from the processor, information about the subset of the requests to the second user device.

14. The method of claim 13 further comprising:
receiving, at the processor from the second user device, a selection from amongst the subset of requests; and
transmitting, by the processor to a first user device associated with the selected request, information that the request will be accommodated.

15. The method of claim 13 further comprising:
receiving, at the processor from the second user device, a selection from amongst the subset of requests;
generating, by the processor and subsequent to receiving the selection, a proposed transportation route that accommodates the selected request; and
transmitting, from the processor, the proposed transportation route to the second user device.

16. The method of claim 13 further comprising:
generating, by the processor and for each request of the subset of requests, a potential transportation route that accommodates the associated request; and
transmitting, from the processor, the potential transportation routes to the second user device.

17. An electronic device comprising:
an input component configured to receive inputs from a user;
an output component configured to provide outputs to the user;
a processor coupled to the input component and the output component; and
a computer-readable storage medium containing program instructions, that, when executed by the processor, cause the processor to:
identify, for each member of a social group, an initial location;
estimate that the members of the social group are attempting to meet at a destination location;
generate a proposed transportation route that extends from a first initial location of the initial locations to one or more second initial locations of the initial locations and terminates at the destination location, wherein the first or second initial locations is an initial location associated with a member associated with the mobile electronic device;
transmit the proposed transportation route to another associated with a member of the social group; and
receive, from the other device, an indication that the member accepts the proposed transportation route.

18. The electronic device of claim 17 further comprising determining the initial location associated with a member associated with the mobile electronic device based on one or more detected locations of the mobile electronic device.

19. The electronic device of claim 17 further comprising:
presenting the proposed transportation route via the output component; and
receiving, via the input component, an indication that a user of the mobile electronic device accepts the proposed transportation route.

20. The electronic device of claim 17 wherein estimating that the members of the social group are attempting to meet at the destination location comprises:
accessing data pertaining to an electronic invitation to an event at the destination location; and
determining that the members of the social group accepted the invitation.

21. The electronic device of claim 17 wherein generating the proposed transportation route comprises:
generating a plurality of potential transportation routes;
defining an efficiency variable for each of the potential transportation routes; and
selecting the proposed transportation route from amongst the plurality of transportation routes based on the efficiency variables.

22. A electronic device comprising:
an input component configured to receive inputs from a user;
an output component configured to provide outputs to the user;
a processor coupled to the input component and the output component; and
a computer-readable storage medium containing program instructions, that, when executed by the processor, cause the processor to:
receive, via the input component, a request for a transportation-route accommodation, the request identifying a social group;
generate a proposed transportation route that extends from a first initial location to one or more second initial locations and that accommodates the request, the first initial location and the second initial location being associated with different members of the social group;
transmit the proposed transportation route to a user device associated with a member of the social group; and
receive, from the user device, an indication that the proposed transportation route is accepted.

23. The electronic device of claim 22 wherein the processor is further configured to transmit the proposed transportation route to a set of user devices, each user device being associated with a member of the social group.

24. The electronic device of claim 22 wherein the request includes a request to pick up a user associated with the mobile electronic device.

25. The electronic device of claim 22 wherein the request for the transportation-route accommodation is received from a second member of the social group via an electronic device or a web interface.

26. The electronic device of claim 22 wherein the processor is further configured to detect a location of the mobile electronic device, wherein the one or more second initial locations includes the detected location.
